(19) United States
(12) Patent Application Publication
(10) Pub. No.: US 2019/0368359 A1
(43) Pub. Date: Dec. 5, 2019

(54) SQUEALER SHELF AIRFOIL TIP

(71) Applicant: United Technologies Corporation, Farmington, CT (US)

(72) Inventors: San Quach, Southington, CT (US); Tania Bhatia Kashyap, West Hartford, CT (US); David Dwyer Whittle, Sandwich, MA (US); Jonathan A. Gomez-Leon, Hartford, CT (US)

(21) Appl. No.: 15/997,961

(22) Filed: Jun. 5, 2018

(51) Int. Cl. F01D 5/20; F01D 5/18; F01D 5/14

(52) U.S. Cl. CPC F01D 5/20; F01D 5/187; F05D 2230/21; F05D 2240/307; F05D 2260/202; F01D 5/147

(57) ABSTRACT

A turbine airfoil for a gas turbine engine according to an exemplary embodiment of this disclosure includes among other possible things, a tip portion including a pocket portion that transitions into a shelf portion and a plurality of cooling holes for communicating cooling airflow to at least one of the pocket portion and the shelf portion.

### BACKGROUND

A gas turbine engine typically includes a fan section, a compressor section, a combustor section and a turbine section. Air entering the compressor section is compressed and delivered into the combustion section where it is mixed with fuel and ignited to generate a high-energy exhaust gas flow. The high-energy exhaust gas flow expands through the turbine section to drive the compressor and the fan section. The compressor section typically includes low and high pressure compressors, and the turbine section includes low and high pressure turbines.

Turbine blades operate in an environment of high temperatures and pressures. High heat loads on the turbine blades necessitate the use of a cooling airflow along surfaces of the turbine blade including its tip. Erosion and oxidation of the turbine blade at the tip can cause premature degradation that impacts performance, and can require replacement.

Turbine engine manufactures continue to seek improvements to engine performance including improvements to thermal and propulsive efficiencies.

### SUMMARY

A turbine airfoil for a gas turbine engine according to an exemplary embodiment of this disclosure includes among other possible things, a tip portion including a pocket portion that transitions into a shelf portion and a plurality of cooling holes for communicating cooing airflow to at least one of the pocket portion and the shelf portion.

In a further embodiment of the foregoing turbine airfoil for a gas turbine engine, the tip portion includes an uninterrupted suction side wall with a width that varies from a leading edge toward a trailing edge.

In a further embodiment of any of the foregoing turbine airfoil for a gas turbine engine, a transition between the pocket portion and the shelf portion and the width of the suction side wall is greater aft of the transition than forward of the transition.

In a further embodiment of any of the foregoing turbine airfoil for a gas turbine engine, the tip portion includes a pressure side wall that extends from the leading edge to the shelf portion.

In a further embodiment of any of the foregoing turbine airfoil for a gas turbine engine, the shelf portion includes an aft end forward of a trailing edge.

In a further embodiment of any of the foregoing turbine airfoil for a gas turbine engine, a transition is included between the pocket portion and the shelf portion. The transition includes a transition width between a suction side wall and a pressure side wall that is less than at least one of a maximum width of the pocket portion and a maximum width of the shelf portion.

In a further embodiment of any of the foregoing turbine airfoil for a gas turbine engine, a first bottom surface in the pocket portion and a second bottom surface in the shelf portion is included, and the first bottom surface and the second bottom surfaces are disposed at different depths.

In a further embodiment of any of the foregoing turbine airfoil for a gas turbine engine, the first bottom surface is at a first depth greater than a second depth of the second bottom surface.

In a further embodiment of any of the foregoing turbine airfoil for a gas turbine engine, a sloped transition surface between the first bottom surface and the second bottom surface is included.

In a further embodiment of any of the foregoing turbine airfoil for a gas turbine engine, a step transition is between the first bottom surface and the second bottom surface.

In a further embodiment of any of the foregoing turbine airfoil for a gas turbine engine, the pocket portion includes a length along a camber line that is different than a length of the shelf portion along the camber line.

In a further embodiment of any of the foregoing turbine airfoil for a gas turbine engine, the shelf portion includes a width transverse to a camber line that is less than a width of the pocket portion transverse to the camber line.

In a further embodiment of any of the foregoing turbine airfoil for a gas turbine engine, a coating is included on surfaces of the pocket portion and the shelf portion.

A gas turbine engine according to an exemplary embodiment of this disclosure includes among other possible things, a turbine section that includes a plurality of turbine blades. At least one of the plurality of turbine blades includes a tip portion including a pocket portion that transitions into a shelf portion and a plurality of cooling holes for communicating cooing airflow to at least one of the pocket portion and the shelf portion.

In a further embodiment of the foregoing gas turbine engine, the tip portion includes an uninterrupted suction side wall with a width that varies from a leading edge toward a trailing edge, and a pressure side wall that extends from the leading edge to the shelf portion.

In another embodiment of any of the foregoing gas turbine engines, a transition is included between the pocket portion and the shelf portion. The transition includes a transition width between a suction side wall and a pressure side wall that is less than at least one of a maximum width of the pocket portion and a maximum width of the shelf portion.

In another embodiment of any of the foregoing gas turbine engines, a first bottom surface is included in the pocket portion. A second bottom surface in the shelf portion and the first bottom surface and the second bottom surfaces are disposed at different depths.

A method of making an airfoil for a turbine section of a gas turbine engine according to an exemplary embodiment of this disclosure includes, among other possible things, forming an airfoil to include a pressure side and suction side extending between a leading edge, trailing edge a tip and a root; forming the tip to include a pocket portion; and forming a shelf portion aft of the pocket portion. The shelf portion opens at least partially into the pocket portion and a pressure side wall varies in width between the pocket portion and the shelf portion.

In a further embodiment of the foregoing method of making an airfoil for a turbine engine, forming a transition portion between the pocket portion and the shelf portion is included. The transition portion includes an open width less than a maximum width of the pocket portion.

In a further embodiment of the any of the foregoing methods of making an airfoil for a turbine engine, forming the pocket portion with a first bottom surface at a first depth, the shelf portion with a second bottom surface at a second depth different than the first depth, and the transition portion with a transition portion between the first bottom surface and the second bottom surface is included.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is a perspective view of an example turbine blade embodiment.

FIG. 3 is a perspective view of a tip portion of the example turbine blade.

FIG. 4 is a top view of the example turbine blade.

FIG. 5 is a cross-sectional view of a portion of the turbine blade tip portion.

FIG. 6 is a cross-sectional view of a portion of another turbine blade tip portion embodiment.

FIG. 7 is a cross-sectional view of a portion of yet another turbine blade tip portion embodiment.

FIG. 8 is a schematic view of the turbine blade tip portion.

### DETAILED DESCRIPTION

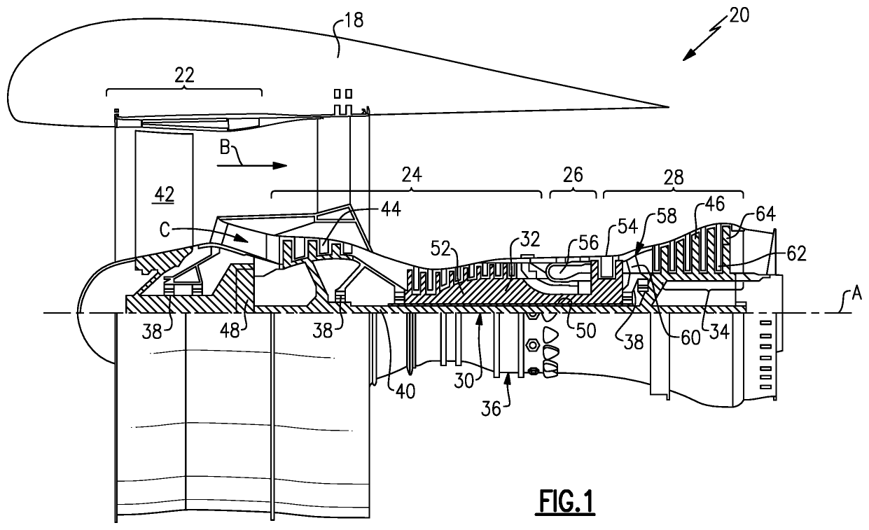

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B in a bypass duct defined within a nacelle 18, and also drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to the fan section 22 through a speed change mechanism, which in exemplary gas turbine engine 20 is illustrated as a geared architecture 48 to drive fan blades 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 58 of the engine static structure 36 may be arranged generally between the high pressure turbine 54 and the low pressure turbine 46. The mid-turbine frame 58 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 58 includes airfoils 60 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan section 22 may be positioned forward or aft of the location of geared architecture 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1 and less than about 5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]0.5. The “Low corrected fan tip speed” as disclosed herein according to one non-limiting embodiment is less than about 1150 ft/second (350.5 meters/second).

The example gas turbine engine includes the fan section 22 that comprises in one non-limiting embodiment less than about 26 fan blades 42. In another non-limiting embodiment, the fan section 22 includes less than about 20 fan blades 42. Moreover, in one disclosed embodiment the low pressure turbine 46 includes no more than about 6 turbine rotors schematically indicated at 34. In another non-limiting example embodiment the low pressure turbine 46 includes about 3 turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

The turbine section 28 includes turbine blades 64 alternating between turbine vanes 62. The turbine blades 64 rotate with the corresponding spools 30, 32 and the vanes 64 remain fixed and direct airflow into the next rotating turbine blade 64. The blades 62 and vanes 64 encounter extreme temperatures and pressures and therefore receive cooling air to maintain temperatures within defined operational limits. Moreover, the blades 62 and vanes 64 include features that aid in maintaining operation for predefined periods at the extreme temperatures.

Referring to FIG. 2, with continued reference to FIG. 1, a turbine blade 64 is shown by way of example and includes an airfoil 65 extending from a platform 66. The airfoil 65 includes a pressure side 74 and a suction side 76 that extend from the platform 66 to a tip portion 68 and from a leading edge 70 to a trailing edge 72. The example turbine blade 64 includes cooling openings 78 that discharge cooling air over external surfaces.

The tip portion 68 includes a pocket portion 80 and shelf portion 82 that are coupled through a transition portion 84. The pocket portion 80 and the shelf portion 82 include cooling air openings 78. The pocket portion 80 and shelf portion 82 provide for improved cooling air efficiencies by reducing required cooling airflow. The pocket portion 80 creates a pocket of cooling air to shield the blade material from heat load due to hot gases.

The pocket portion 80 is substantially surrounded by the sides 74 and 76 except for within the transition portion 84 that provides communication with the shelf portion 82. The shelf portion 82 is open on the pressure side 74 and is a cut away portion that includes an opening. The transition portion 84 bridges between the pocket portion 80 and shelf portion 82.

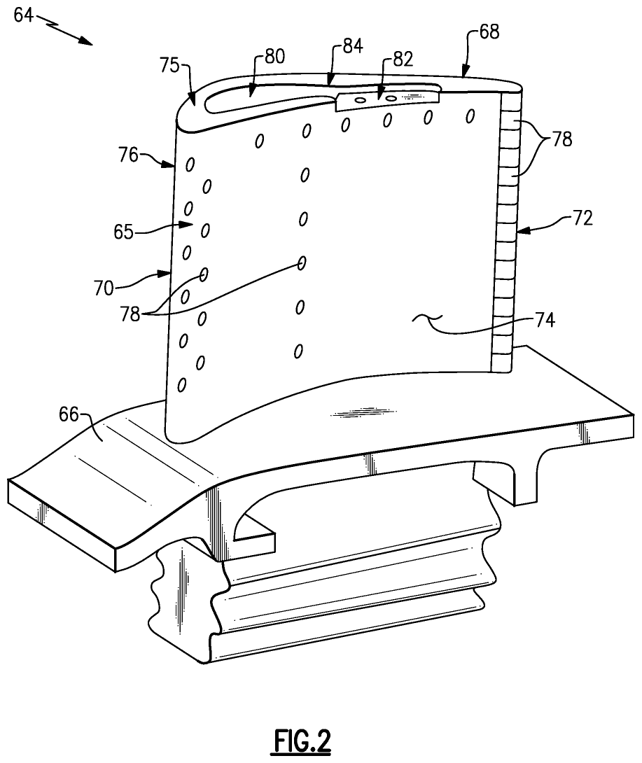

Referring to FIGS. 3 and 4 with continued reference to FIG. 2, the pocket portion 80 is disposed between a pressure side wall 96 and a suction side wall 94. The suction side wall 94 extends from the leading edge 70 uninterrupted to the trailing edge 72. It should be appreciated, that the suction side wall 94 may include cooling openings and still be considered uninterrupted for purposes of this disclosure. The pressure side wall 96 extends from the leading edge 70 toward the trailing edge 72 and is interrupted by the shelf portion 82. The shelf portion 82 defines an opening 90 with a width 92. The opening 90 includes an aft most end 114 that in this disclosed example is spaced from the trailing edge 72 a distance 118. Accordingly, in this disclosed example, the shelf portion 82 does not extend to the trailing edge 72.

The pocket portion 80, the transition 84 and the shelf portion 82 may all include a coating schematically shown at 128 to enhance the ability to operate within the extreme temperatures. Moreover, the example turbine blade 64 is fabricated from known materials utilized within the turbine section of a gas turbine engine and that are compatible with the temperatures and pressures encountered therein.

The suction side wall 94 varies in width between the leading edge and trailing edge 72. In this disclosed embodiment, the suction side wall 94 includes a width 86 within the pocket portion 80 that transitions to a width 85 within the transition 84 and subsequently to a width 88 defined in the shelf portion 82. In this disclosed embodiment, the width 88 adjacent the shelf portion 82 is greater than either the width 85 or the width 86. The increased width of the suction side wall 96 provides differing features to tailor cooling in view of localized heat loads.

The transition 84 includes a width 108 that is less than a maximum width 112 of the pocket portion 80. The transition 84 thereby necks down to a reduced width as the suction side wall 94 increases in width. The transition 84 leads into the shelf portion 82 where the shelf portion 84 includes a maximum width 110. In this disclosed embodiment, the maximum width 110 of the shelf portion 82 is less than the maximum width 112 in the pocket portion 80. The width 108 in the transition 84 is less than either the maximum width 112 or maximum width 110.

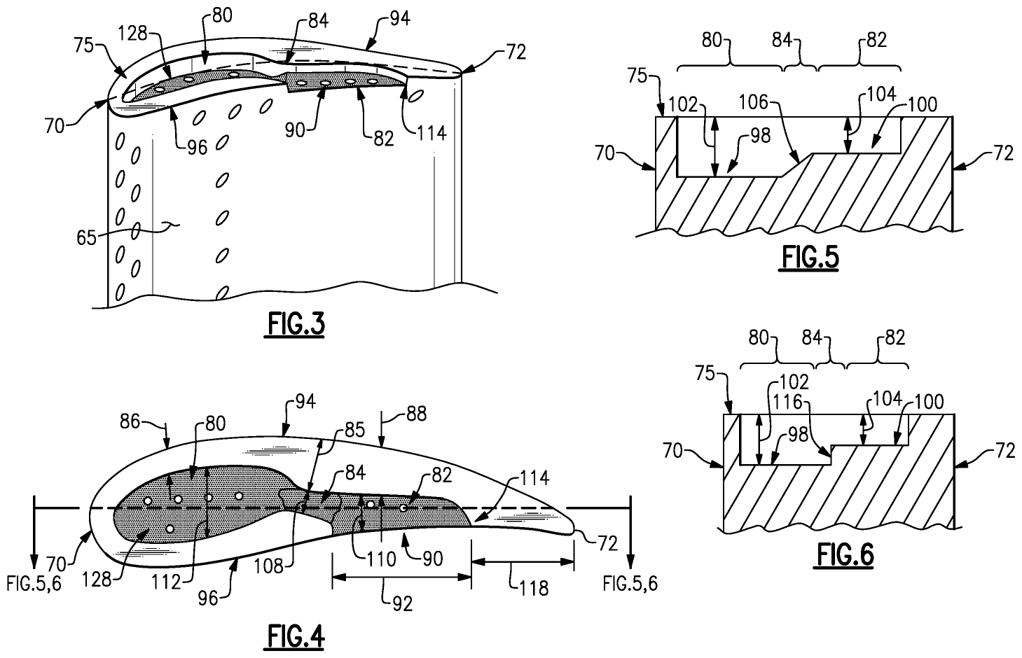

Referring to FIG. 5, with continued reference to FIG. 4, the pocket portion 80 includes a bottom surface 98 disposed at a first depth 102 from the top surface 75. The shelf portion includes a bottom surfaces 100 that is spaced at a second depth 104 from the top surface 75. The transition 84 includes a transition surface 106 that in this disclosed example is sloped upward from the bottom surface 98 in the pocket portion 80 to the bottom surface 104 in the shelf portion 82. The transition surface 106 can be sloped as shown in FIG. 5 and/or contoured to provide features that encourage cooling air flow between the pocket portion 80 and the shelf portion 82.

Referring to FIG. 6, with continued reference to FIG. 4, the transition 84 includes a step 116 between the surfaces 98 and 100. The step 116 provides different flow characteristics between the pocket portion 80 and the shelf portion 82 that may be desirable to tailor cooling airflow to accommodate localized heat loads.

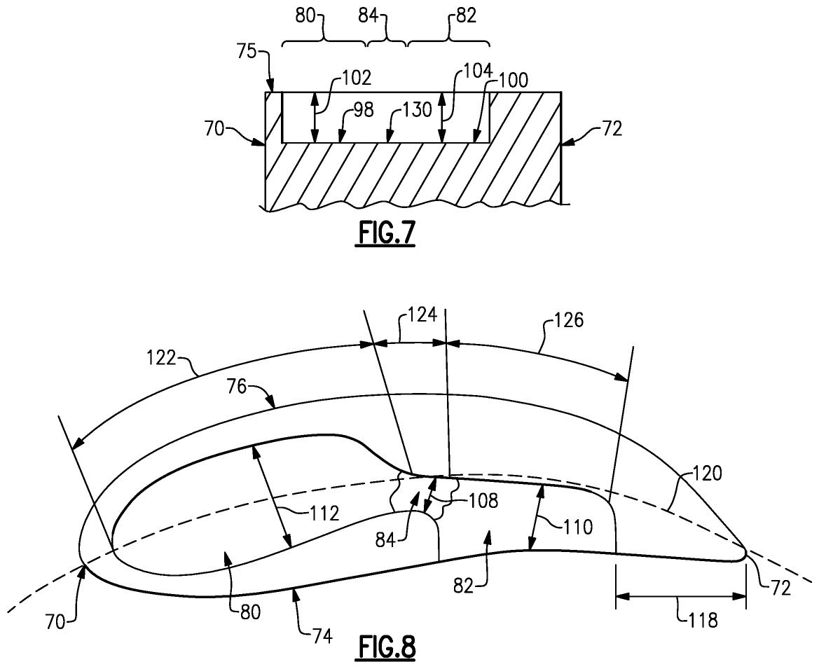

Referring to FIG. 7, with continued reference to FIG. 4, another example tip portion 68 includes depth 102 in the pocket portion 80 and depth 104 in the shelf portion 104 that are the same. The transition 84 includes a surface 130 that is also at the common depth with the surfaces 98 and 100. It should be appreciated, that the surfaces 98 may be flat, contoured or curved and included openings for cooling air. Moreover, other combinations of depths in the pocket portion 80, shelf portion 82 and transition 84 could be utilized to address location specific heat loads and are within the contemplation of this disclosure.

Referring to FIG. 8, with continued reference to FIG. 4, the disclosed turbine blade 64 includes a camber line 120 that extends from the leading edge 70 to the trailing edge 72. The pocket portion 80 includes a length 122 along the camber line 120 that is, in this disclosed example greater than a length 126 of the shelf portion 82 along the camber line 120. The example transition 84 includes a length 124 that is smaller than either the length 122 or the length 126. It should be appreciated, that the length 124 may vary depending on application specific requirements. The pocket portion 80 includes an open width 112 in a direction transverse to the camber line 120 that is larger than an open width 110 of the shelf portion 82 transverse to the camber line 120. Accordingly, the width of the pocket portion 80 is greater than the width of the shelf portion 82 in this disclosed example embodiment. The transition 84 includes a width 108 transverse to the camber line 120 that is less than either the width 112 or the width 110. The reduced width of the transition 84 provides communication between the pocket portion 80 and the shelf portion 82 while also maintaining cooling airflow as needed to address localized heat loads.

The example turbine blade 64 can be formed utilizing known fabrication techniques and includes forming the airfoil 65 to include the pressure side 74 and the suction side 76 extending between the leading edge 70, trailing edge 72, the tip 68 and the platform 66. The tip 68 is formed to include the pocket portion 80 and the shelf portion 82 in communication through the transition 84. The shelf portion 82 can be cast as part of the original forming process or machined after formation of the pocket portion 80. Machining the shelf portion 82 after formation of the turbine blade 64 enables retrofitting of existing turbine blades to address specific determined localized heat loads.

The shelf portion 82 is formed aft of the pocket portion 80 such that the shelf portion 82 opens at least partially into the pocket portion 80 through the transition 84. The pocket portion 80 and the shelf portion 82 are formed to include the above disclosed variations in widths 86, 85, and 88 of the pressure side wall. The widths 86, 85 and 88 vary from the leading edge 70 toward the trailing edge 72. Forming the pocket portion 80 includes forming the bottom surface 98 at the first depth 102, the shelf portion 82 with the bottom surface 100 at the second depth 104 different than the first depth 102 and the transition surface 84 between the first bottom surface and the second bottom surface. The transition surface 84 can be formed as cast with the cast shelf portion 82 or alternatively, machined with the shelf portion 82 to retrofit existing blades.

Accordingly, the example turbine blade 64 includes a pocket portion 80 that is in communication with a shelf portion 82 through a transition 84 to enable localized accommodation of specific heat loads to increase operational life.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A turbine airfoil for a gas turbine engine comprising:
a tip portion including a pocket portion that transitions into a shelf portion; and
a plurality of cooling holes for communicating cooing airflow to at least one of the pocket portion and the shelf portion.

2. The turbine airfoil as recited in claim 1, wherein the tip portion includes an uninterrupted suction side wall with a width that varies from a leading edge toward a trailing edge.

3. The turbine airfoil as recited in claim 2, including a transition between the pocket portion and the shelf portion and the width of the suction side wall is greater aft of the transition than forward of the transition.

4. The turbine airfoil as recited in claim 2, wherein the tip portion includes a pressure side wall that extends from the leading edge to the shelf portion.

5. The turbine airfoil as recited in claim 1, wherein the shelf portion includes an aft end forward of a trailing edge.

6. The turbine airfoil as recited in claim 1, including a transition between the pocket portion and the shelf portion, the transition including a transition width between a suction side wall and a pressure side wall that is less than at least one of a maximum width of the pocket portion and a maximum width of the shelf portion.

7. The turbine airfoil as recited in claim 1, including a first bottom surface in the pocket portion and a second bottom surface in the shelf portion and the first bottom surface and the second bottom surfaces are disposed at different depths.

8. The turbine airfoil as recited in claim 7, wherein the first bottom surface is at a first depth greater than a second depth of the second bottom surface.

9. The turbine airfoil as recited in claim 7, including a sloped transition surface between the first bottom surface and the second bottom surface.

10. The turbine airfoil as recited in claim 7, wherein a step transition between the first bottom surface and the second bottom surface.

11. The turbine airfoil as recited in claim 1, wherein the pocket portion includes a length along a camber line that is different than a length of the shelf portion along the camber line.

12. The turbine airfoil as recited in claim 1, wherein the shelf portion includes a width transverse to a camber line that is less than a width of the pocket portion transverse to the camber line.

13. The turbine airfoil as recited in claim 1, including a coating on surfaces of the pocket portion and the shelf portion.

14. A gas turbine engine comprising:
a turbine section including a plurality of turbine blades, wherein at least one of the plurality of turbine blades includes a tip portion including a pocket portion that transitions into a shelf portion and a plurality of cooling holes for communicating cooing airflow to at least one of the pocket portion and the shelf portion.

15. The gas turbine engine as recited in claim 14, wherein the tip portion includes an uninterrupted suction side wall with a width that varies from a leading edge toward a trailing edge and a pressure side wall that extends from the leading edge to the shelf portion.

16. The gas turbine engine as recited in claim 14, including a transition between the pocket portion and the shelf portion, the transition including a transition width between a suction side wall and a pressure side wall that is less than at least one of a maximum width of the pocket portion and a maximum width of the shelf portion.

17. The gas turbine engine as recited in claim 14, including a first bottom surface in the pocket portion and a second bottom surface in the shelf portion and the first bottom surface and the second bottom surfaces are disposed at different depths.

18. A method of making an airfoil for a turbine section of a gas turbine engine, the method comprising:
forming an airfoil to include a pressure side and suction side extending between a leading edge, trailing edge a tip and a root;
forming the tip to include a pocket portion; and
forming a shelf portion aft of the pocket portion, wherein the shelf portion opens at least partially into the pocket portion and a pressure side wall varies in width between the pocket portion and the shelf portion.

19. The method as recited in claim 18, including forming a transition portion between the pocket portion and the shelf portion with the transition portion including an open width less than a maximum width of the pocket portion.

20. The method as recited in claim 19, including forming the pocket portion with a first bottom surface at a first depth, the shelf portion with a second bottom surface at a second depth different than the first depth and the transition portion with a transition portion between the first bottom surface and the second bottom surface.
